(19) United States
(12) Patent Application Publication
(10) Pub. No.: US 2015/0235243 A1
(43) Pub. Date: Aug. 20, 2015

(54) ENGAGEMENT TOOL FOR A WEBSITE

(71) Applicant: Sentiment 360 Ltd., Nottinghamshire (GB)

(72) Inventors: Christopher James Wilson, Nottinghamshire (GB); Flint Barrow, Atlanta, GA (US)

(21) Appl. No.: 14/422,580

(22) PCT Filed: Oct. 30, 2012
(86) PCT No.: PCT/IB12/56016

§ 371 Date: Feb. 19, 2015

Related U.S. Application Data
(60) Provisional application No. 61/691,895, filed on Aug. 22, 2012.

(51) Int. Cl. G06Q 30/02

(52) U.S. Cl. CPC G06Q 30/0203

(57) ABSTRACT

A method of collecting and analyzing data over a network is disclosed which for embedding in webpages and which collects feedback from a plurality of users, and processes the feedback to detect sentiment, which may be presented in a chart. Processing may comprise parsing the feedback, breaking it down into parts, labelling the parts and assigning a numerical value depending on sentiment. The chart may form part of an intuitive and simple to use dashboard display.

### FIELD OF THE INVENTION

The invention provides an engagement tool for websites (“widget” or “tool”). It is capable of being embedded in multiple locations while collating input from those sources into a central location.

### BACKGROUND OF THE INVENTION

The tool builds on work done at a Georgia Tech startup, Enkia, who has a solid history with natural language processing and specifically their sentiment analysis tools. A goal of the tool is to remain simple and intuitive. Other tools in the market tend to be complicated, expensive and require training. The widget is the other side of the coin offering a simple solution to engage users, gather targeted data, and explore conversations.

### BRIEF SUMMARY OF THE INVENTION

Many advantages of the invention will be determined and are attained by the invention, which in a broadest sense provides a computer widget that collects and transforms data for analysis and feedback.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE FIGURES

For a better understanding of the invention, reference is made to the following description, taken in conjunction with the accompanying drawings, in which like reference characters refer to like parts throughout, and in which:

FIG. 1 illustrates a database that may be used as a persistence mechanism for use with aspects of the invention;

FIG. 2 illustrates a bar graph of topics with associated sentiments going upwards for positive and downward for negative in accordance with embodiments of the invention;

FIG. 3 an intuitive pie chart with each slice as a topic and its size as the number of times it was mentioned in accordance with the invention;

FIG. 4 illustrates an area graph that shows if something is gaining popularity or losing popularity in accordance with embodiments of the invention;

FIG. 5 is a motion chart which relies on animation to show how data is changing over time;

FIG. 6 illustrates an example of a visualization of special ATNs for representing score prediction data in accordance with embodiments of the invention.

FIG. 7 is an example of how an advert in a webpage provided as part of a brand advertising campaign widget might be provided in accordance with an aspect of the invention;

FIG. 8 illustrates a webpage reached when clicking through the advert of FIG. 7;

FIG. 9 is an enlarged view of a cloudtag and answer field part of the webpage of FIG. 8;

FIG. 10 is a representation of a dashboard associated with the webpage of FIG. 8;

FIGS. 11 to 14 are further views of webpage or webparts associated with the advertising widget;

FIG. 15 is an example of a webpage for a sports gambling website;

FIG. 16 illustrates how a gambling widget implemented as a webpart in the site shown in FIG. 16 may appear in accordance with an aspect of the invention;

FIGS. 17 and 18 are screenshots of webparts reached when clicking through the widget shown in FIG. 16;

FIG. 19 illustrates a possible design of dashboard associated with the widget of FIG. 16;

FIG. 20 is a view of a screen reached on click through of an alternative example of a widget for sports gambling that may be provided in accordance with an aspect of the present invention;

FIG. 21 is an illustration of an alternative dashboard for a retailer widget; and

FIG. 22 is a process chart showing the steps that may be carried out in software to implement a widget such as those illustrated in FIGS. 7 to 21.

### DETAILED DESCRIPTION OF THE INVENTION

The principles and operations of the invention may be better understood with reference to the drawings and the accompanying description.

Utilizing cloud solutions that make it possible to deploy these programs on an as needed basis, the widget is capable of delivering fast analytics that are pertinent and relevant. It may work with an outsourced harvesting system enabling the engine to use a cloud replication solution to instantiate multiple instances of the indexer.

While the following description is limited to the Cloud, the invention is not so limited. Those skilled in the art will recognize that the tool could be employed on various types of networks and still fall within a scope of the invention. Beyond trolling the web for massive amounts of data embodiments of the widget seek feedback for desired subjects. In an effort to encourage participation, some or all of the analytics may be made available to the people providing the feedback. In this way the feedback provider obtains added value in experience unlike conventional multiple-choice feedback tools that exist today.

The invention is particularly adaptable to social networks however it is not so limited. It allows a provider to keep these conversations on their site while promoting active feedback by providing an easy way for users to contribute. It also provides tools for them to more easily understand the sub-topics that make up that conversation. Tag clouds, groups of words that are emphasized (e.g. by size and/or color) based on frequency of use help the user quickly see what segments of a conversation are most popular. The user can also explore more about that part of the conversation by targeting a sub-topic and reading only relevant snippets.

The publisher may also want and/or need to control this conversation. To this end, the publisher may be provided with the ability to direct the main subject through a prompt or question and have the further ability to moderate what is shown to the public while having full access to analytics of all data collected. Based on real-time or substantially real-time analytics they may be provided the ability to alter their prompts, redact inappropriate contributors and/or choose to leave it open to criticism. The system is built around open control where the publisher can make decisions instead of the tool dictating its usage. Those skilled in the art will recognize that the widget could also be provided with default topics that may be specific to a particular industry, or the provider and user could see the same analytic results and still fall within a scope of the invention.

Speech tagger: Using the Penn State notation, the standard in natural language processing (“NLP”), words are labeled with their part of speech, e.g. adjective, noun, proper noun, etc. From this heuristics are designed to capture different elements. Using spatial relationships many conclusions about the language are drawn. Adjectives are associated with their respective noun or noun phrase. These rules are known as augmented transition networks (“ATNs”). Some are very general while others serve more domain specific purposes. An example of implementations of these ATNs include: sentiment detection which looks for adjectives and their related noun phrase, feature extraction which looks for topics within the text, and specialized ATNs for things such as extracting a score outcome or prediction from the text in relationship to sports, stocks, etc.

Once these sub-topics and related sentiments have been extracted they are run through a clustering process. Applying numerical values to the words letters it's possible to map them in a large matrix and find ones that are over a threshold of similarity to be considered the same. These are then associated as one entity. Examples of this range from the simplicity of catching different capitalizations, to catching different similar phrasing. “Dealership,” “dealership” and “dealership support” could all be clustered and labeled as references to “dealership.” Similarly the same is done to the extracted sentiments. “Best in class,” “best of class” and “best class” could all be clustered to “best in class.” This is done for all of the found features, or sub-topics, and associated sentiments. The ones that are not merged are also stored with similarity values against other topics which assists in creating interfaces for related features beyond logical coupling (those found together are related) by giving a metric for topics not used together to still be considered related.

These sentiments are compared against a dictionary which has defined values for positivity and negativity to calculate whether the phrase is overall positive or negative. This overall value is associated with the sentiment. Values for the total sentiment of the feature are then based on the collection of sentiments and their positive and negative values.

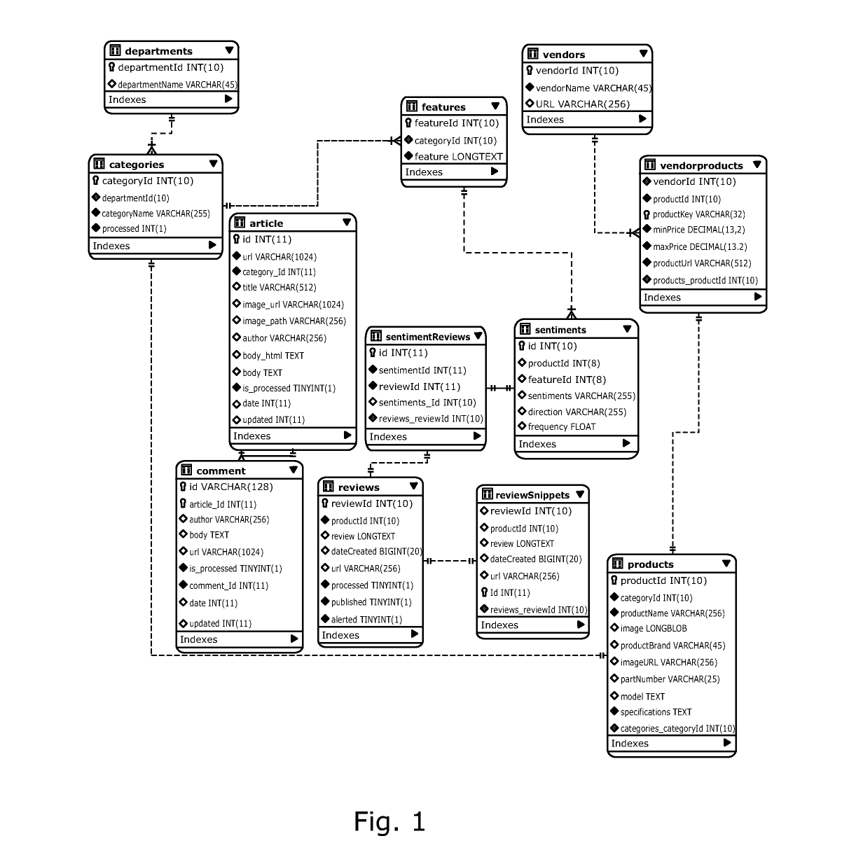

Snippets are computed from the topics to extract smaller blocks of text from the entire answer and are mapped to their original whole text and to the features found within. The user is then shown a snippet related to a given subtopic when trying to explore that part of the conversation. Those skilled in the art will recognize that the user may be provided the whole text and still fall within a scope of the invention. The data is saved in a format that is capable of easy access and querying of subsets. A database may be used as a persistence mechanism that also suits these query-able needs. See FIG. 1. Schema of the database includes ways to format non-indexed data as well as data that has run through the engine and organized such as aforementioned interfaces can be built upon. The schema relies upon relationships within the table represented by dotted lines.

Using cloud computing architecture the process that is run can be parallelized across different sets with multiple computers or cores that allow a large number of widgets to be indexed simultaneously. The database uses scaling and replication as well to ensure performance even when very large. As the database holds the indexed information it is used to create interfaces to for display without those graphic user interfaces needed “knowledge” of the processes running in parallel working to index said data.

The data thus having been transformed from its original raw state to an index state makes creation of valuable interfaces possible. A benefit of this is the exploration of the conversation through the interactive tag cloud. The tag cloud itself makes it easy to see what sub-topics are popular. Beyond this, because snippets are indexed against the extracted features, the user can click on a word in the tag cloud and be shown snippets containing that feature. Because it has been run through a clustering algorithm there may be some variation in phrasing as opposed to pure word matching searching. The publisher may be provided the ability to control some or all of the snippets based on related features or snippets that include two topics and limit the snippets shown by associated sentiment. This allows the publisher to spend time reading parts of the conversation that are important. The value of this feature increases as the conversation size becomes too large to efficiently monitor comment by comment. This interaction of viewing snippets based on a topic, set of topics or topic and sentiment pair is referred to as a topic breakdown or drilldown.

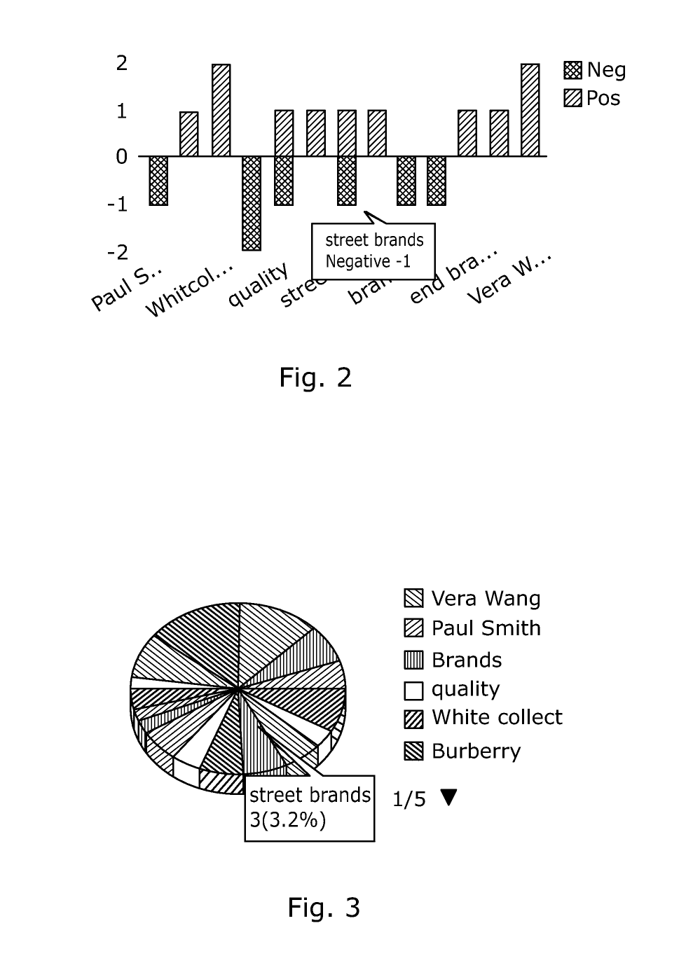

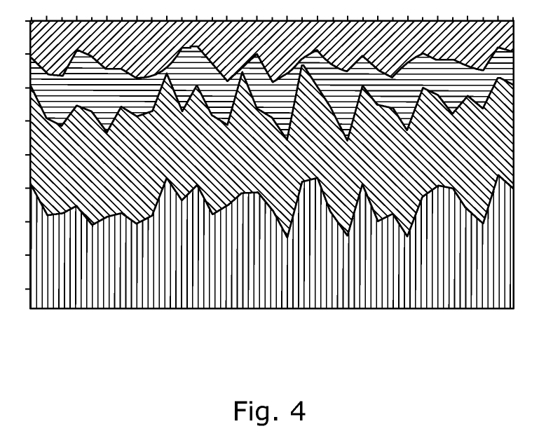

Interfaces that summarize the data are also presented to both the end-user and publisher. The end user may be capable of seeing a share of voice graphs that reinforce the tag clouds' popularity as size by displaying an intuitive pie chart, for example, with each slice as a topic and its size as the number of times it was mentioned. Those skilled in the art will recognize that while pie charts and bar graphs are disclosed, other forms of visual representation may be employed without departing from a scope of the invention. The publisher has access to further analytics and is provided with a share of voice pie graph that can be broken down further into more pieces and a bar graph of topics with associated sentiments going upwards for positive and downward for negative. See FIGS. 2 and 3.

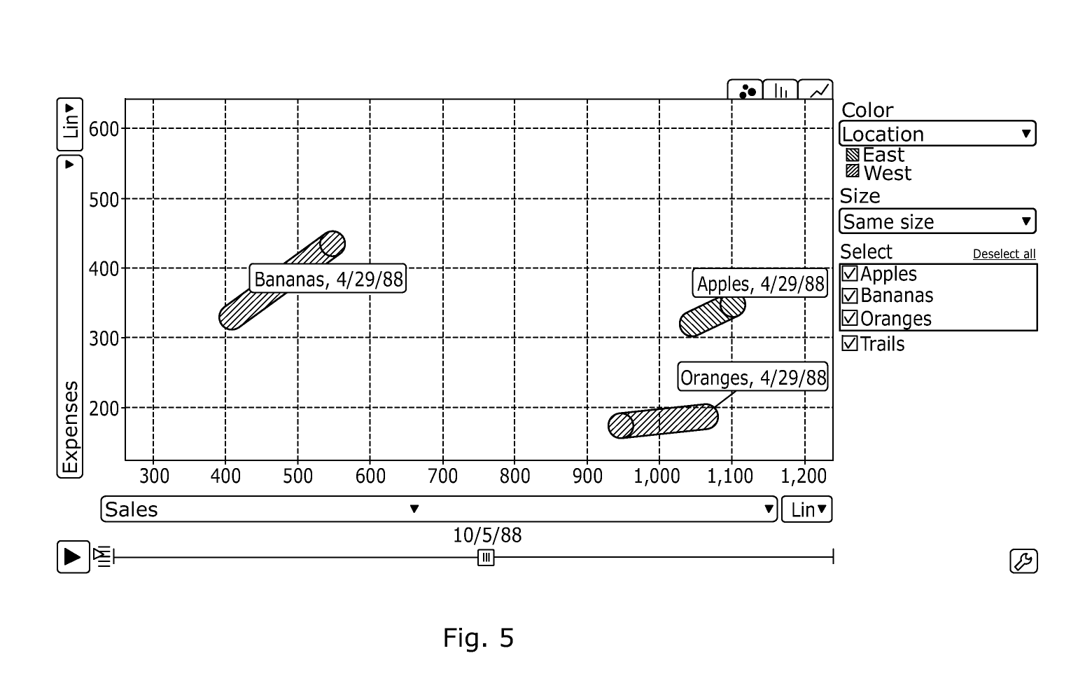

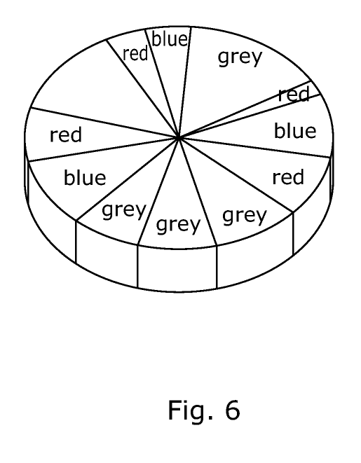

Using the date from the original comment we can group the number of times a Feature/sub-topic was mentioned to create trending graphs. The publisher can know if something is gaining popularity or losing popularity. A common way to show this is to similar to a pie chart drawn out over time and is known as an area graph. See FIG. 4. FIG. 5 shows a motion chart which relies on animation to show how data is changing over time.

Some domains require special consideration. For example, in sports gambling the publisher may pose a question asking for predicted outcomes. Special ATNs cover this case by looking for phrasing of a score outcome as well as correctly associating the winning team. It is typically the team name mentioned closest to the score but also handles negation and other phrasing. See FIG. 6 for a special visualization representing this data. In the drilldown the score outcomes are treated as a sentiment in association to the team with negative sentiment representing a predicted loss and positive sentiment for predicted wins. Those skilled in the art will recognize that sports gambling is merely a non-limiting example and that there may be other predictive type activities.

A dashboard provides access to publisher analytics and may also provide configuration, moderation and publication options. Configuration includes defining the current question and what elements are shown in the widget. This includes deactivating graphs, enabling premium features such as animated tag clouds or specially shaped tag clouds to branding and access. Moderation includes ways to redact negative, foul or manually toggled comments from being shown to the public (or any type of comment that the publisher does not want the viewed by the user). Publication includes the technical needs to embed the widget within a page.

Click-thrus, or using the tag cloud to link to other pages, has applications throughout the project. The simplest is to manually associate a feature (sub-topic) with a web address or URL. On rollover or mouseover of a topic the user may be shown an additional link to “Learn More about _____x_____.” The publisher can define these to redirect a user to other important content or to sponsored pages and ads that relate to the conversation or almost anywhere.

Another use for these links is to use them for navigation. “Find Others with _____x_____” can lead to a search that brings back results based on the feature selected. This also shows how extracted features can be used as an automatic tagging system for search engine optimization by defining keywords to be associated with the page or product.

Thus it is seen that a widget is provided for obtaining, transforming, analyzing and presenting data according to the invention. Although particular embodiments have been disclosed herein in detail, this has been done for purposes of illustration only, and is not intended to be limiting with respect to the scope of the claims which follow. In particular, it is contemplated by the inventor that various substitutions, alterations, and modifications may be made without departing from the spirit and scope of the invention as defined by the claims. The claims presented are representative of the inventions disclosed herein. Other, unclaimed inventions are also contemplated. The inventors reserve the right to pursue such inventions in later claims.

By way of example only, there now follows a description of several possible implementations of widgets operating in accordance with the present invention.

### Jaguar Demo

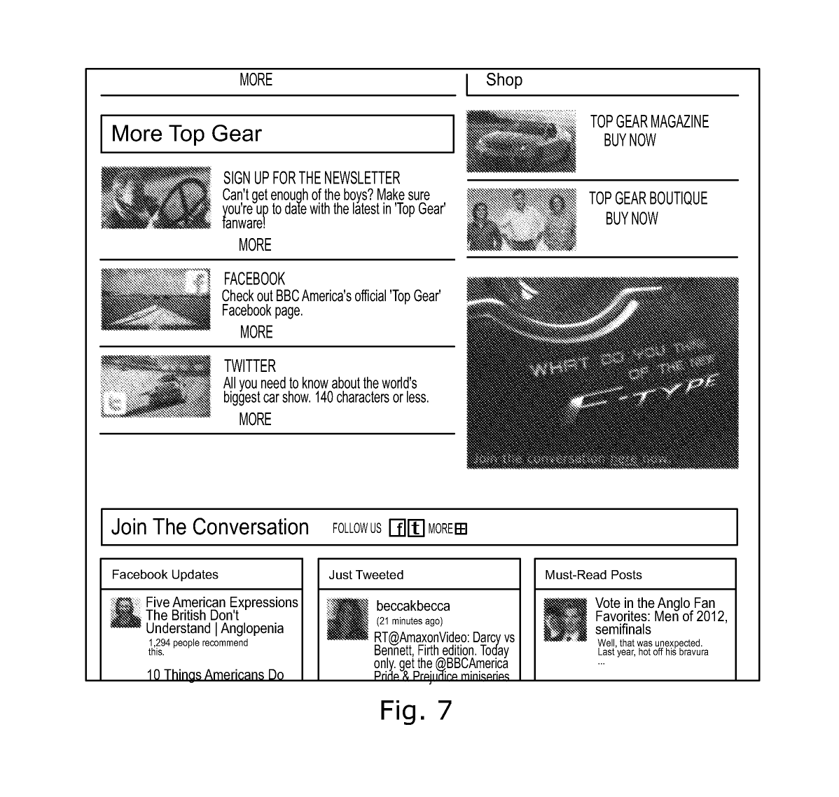

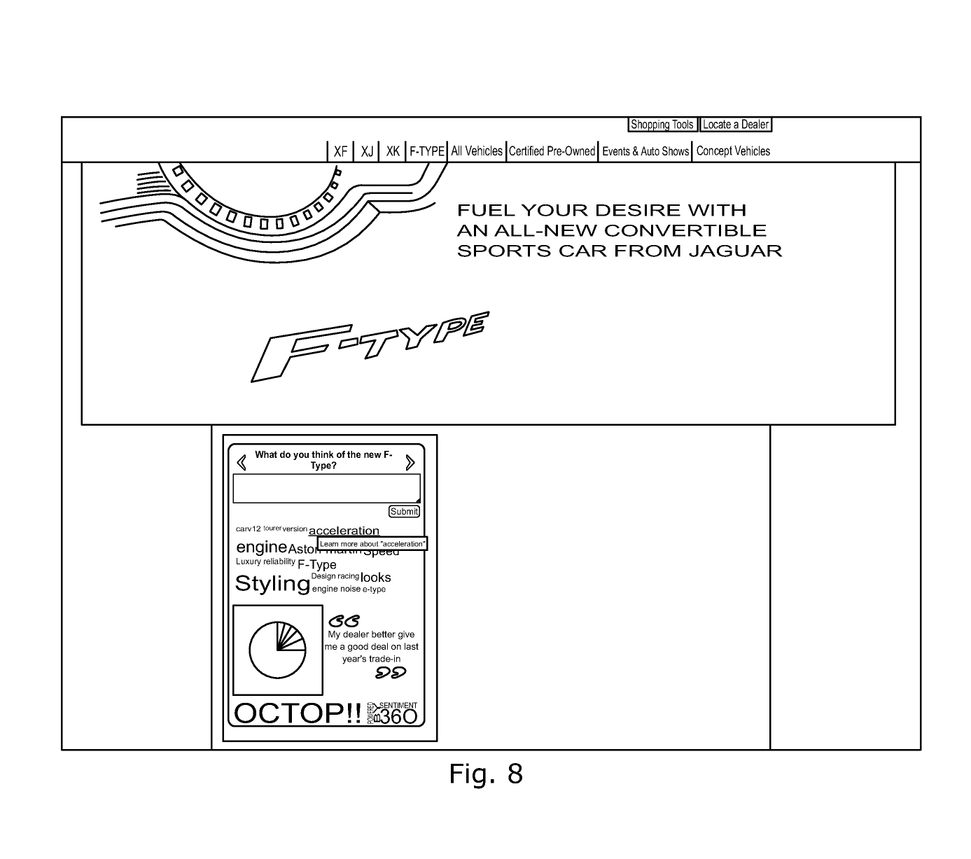

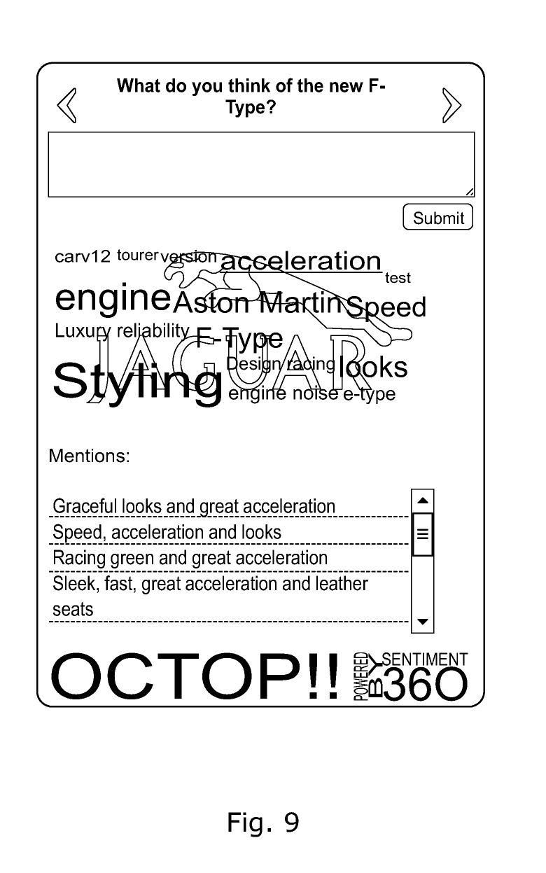

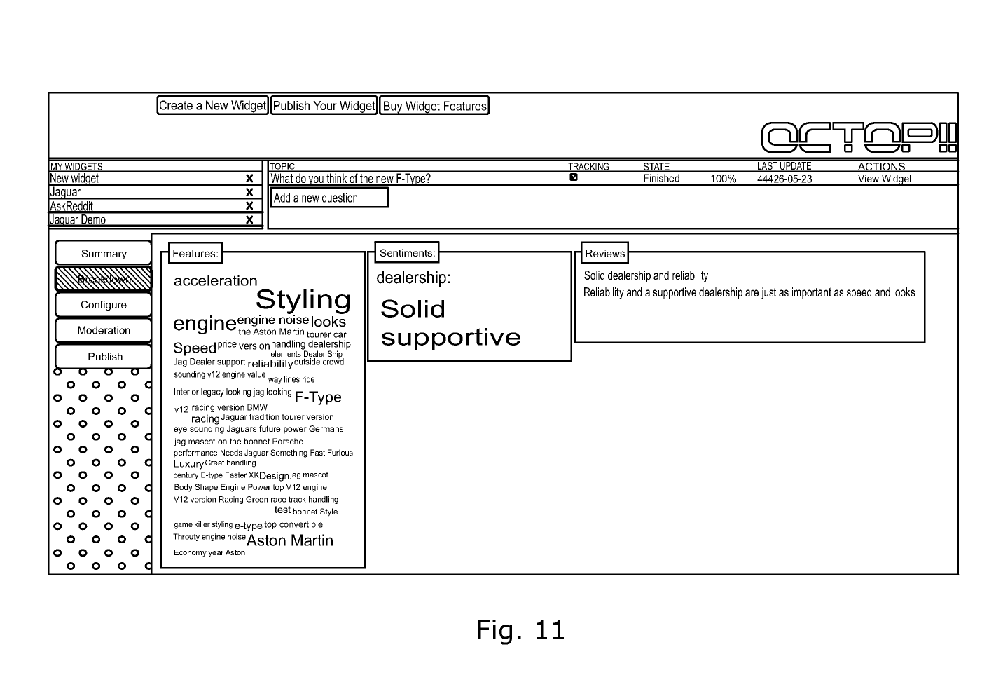

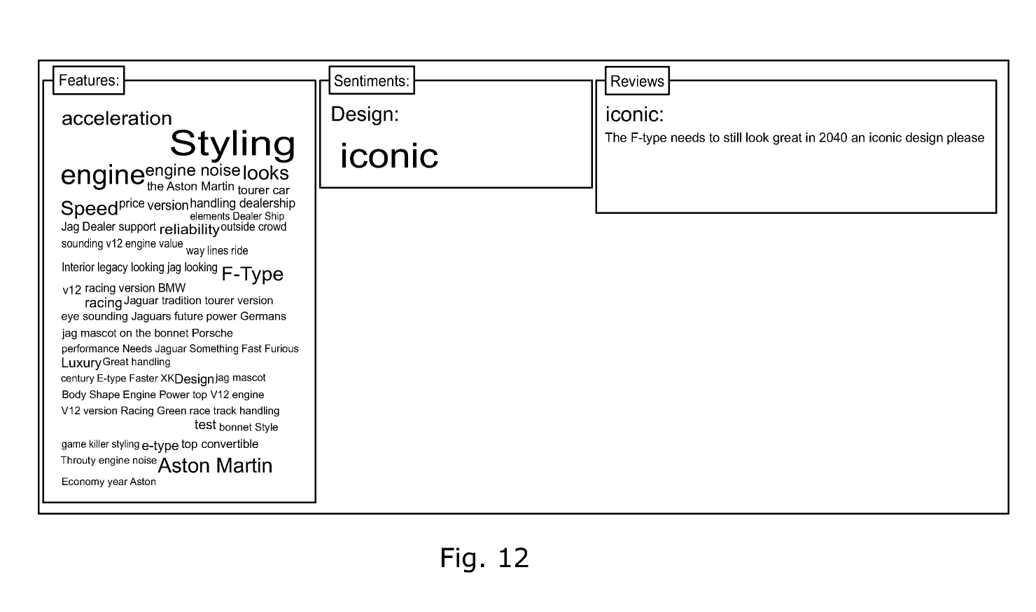

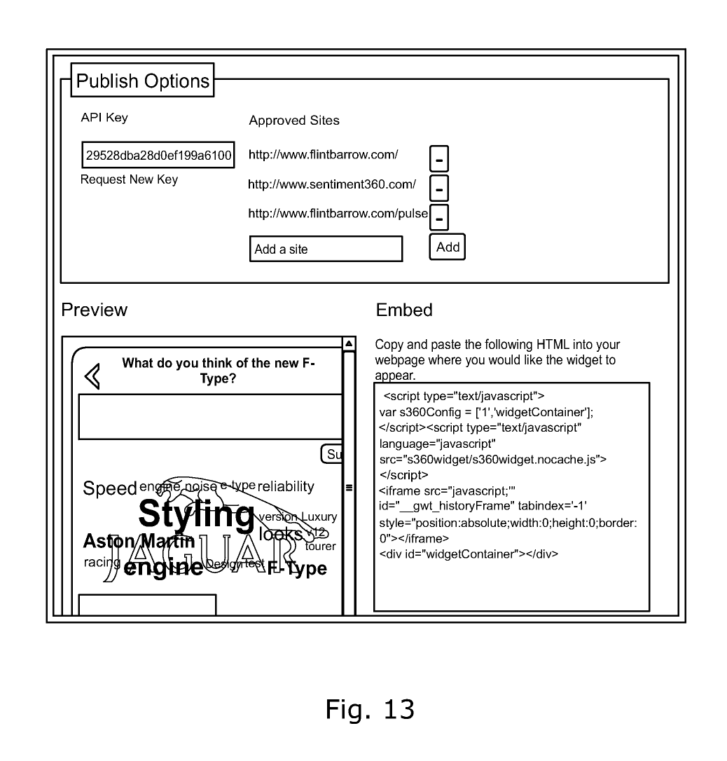

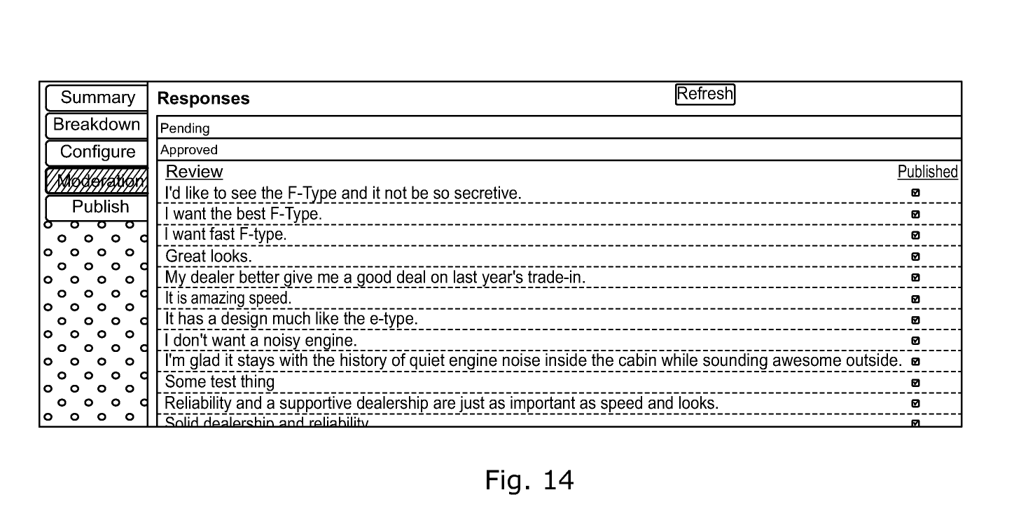

FIGS. 7 to 14 illustrate an example of how the widget system can be utilized by a brand through their site online. In this example the “Jaguar” motor cars brand has been chosen but of course it applies equally to any other brand.

The widget provides direct click-through from brand's advertisement to widget and then through to brand's website. It offers the capability for client to change the host question in any ad campaign at any time to address the host's specific target audience.

Currently no other consumer engagement tool exists at the point of ad service for instance, Facebook and Twitter live “offline” and lose the consumer in navigation

The widget can be seen “Live” in FIG. 7 embedded in a webpage, followed by the

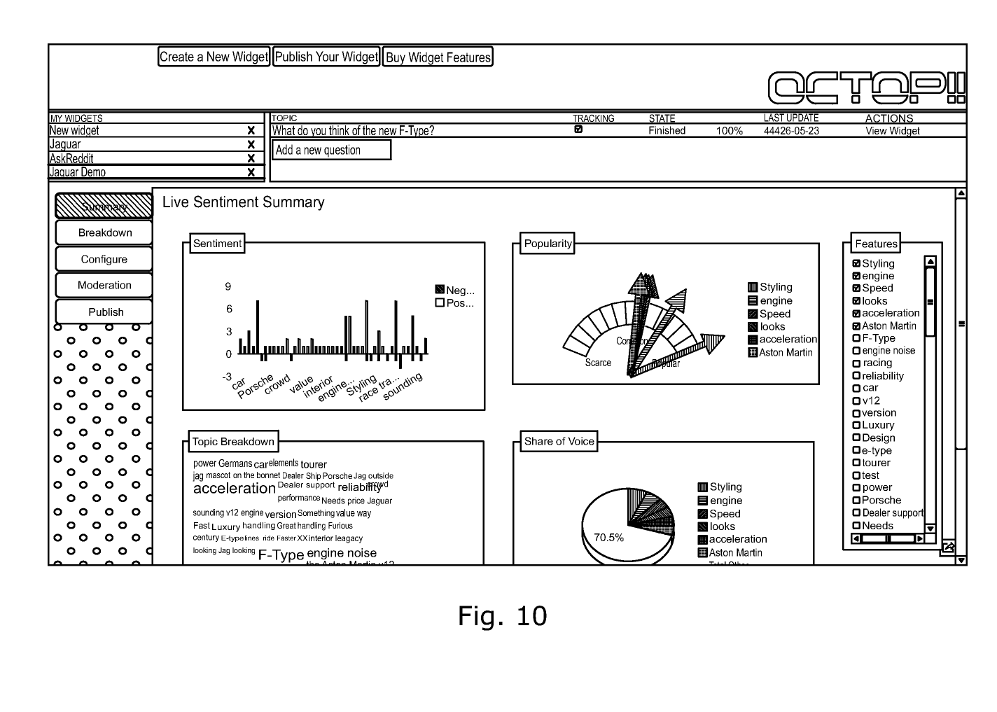

Dashboard additionally described later and shown in FIG. 10. FIG. 7 illustrates a mock up of a JAGUAR AD which may be placed within a website to drive people to the widget for feedback. The widget posing a question is shown with submission box for new answers. The widget includes a ticker showing recent comments, a share of Voice Graph and an exploratory Tag Cloud.

The widget as illustrated includes drill downs including a tag cloud. The size of tags in the tag cloud are determined by the number of times they've been referenced. Larger tags are more common. Clicking a tag brings up comments at the bottom related to that tag. The client can explore the conversation quickly while focusing on topics important to them Longer comments are split into smaller snippets around where a topic was mentioned.

The tag also includes CLICK-THRUS FROM TOPICS. Placing the mouse over a topic can show additional links such as links to the performance page for the word acceleration as defined by the widget publisher.

Once data has been answered as a response to the questions posed in the widget it is processed in the following manner:

Step. 1 For each review within a category do:
parse review into sentences
tag sentences with part of speech using the open NLP library
extract features and sentiment pairs from sentences and hold them in a set of feature/sentiment pairs (see steps below in A.1.1)

Step. 2 For each category do:
cluster features using agglomerative clustering
to do: cluster sentiments within each cluster of features next
assign sentiment clusters a polarity score based on individual sentiment words and their polarity extracted from dictionary

Step. 1.1 For each tagged sentence do:
identify keyword (e.g. adjective) in sentence from sentiment expression list that identifies a possible sentiment expression
if keyword is identified do:
   identify sentiment expression using Augmented Transition Networks (ATNs)
   identify feature expression from nearby words not included in the sentiment expression using ATNs. Note that ATNs definitions are not described in this document.
include sentiment feature pair into a result set for the sentence

The output of Step. 1 is a list of sentiment feature pairs for all reviews. This list is then clustered based on features first and sentiments next to build a structure that identifies common features and their common sentiment expressions.

All information entered through the widget is passed to a PUBLISHER'S DASHBOARD that processes the information and displays the results to the publisher. The Publisher has access to full analytics of data inputted by clients. This includes:
Full Topic Breakdown
Sentiment Analysis of Topics (Positive and negative counts of words describing topic)
Interactive Share of Voice and popularity charts

The dashboard provides for a number of DASHBOARD DRILL DOWNS. These are very similar to the clients ability to view comments related to one topic, the publisher has that capability and more. They can also see sentiments extracted in relation to the topic as well as only view comments with that sentiment.

### Other Dashboard Capabilities

Publisher can manage widgets including:
Configuration
Publication
Features Enabled
Moderation of Comments

### Gambling Demo—Football

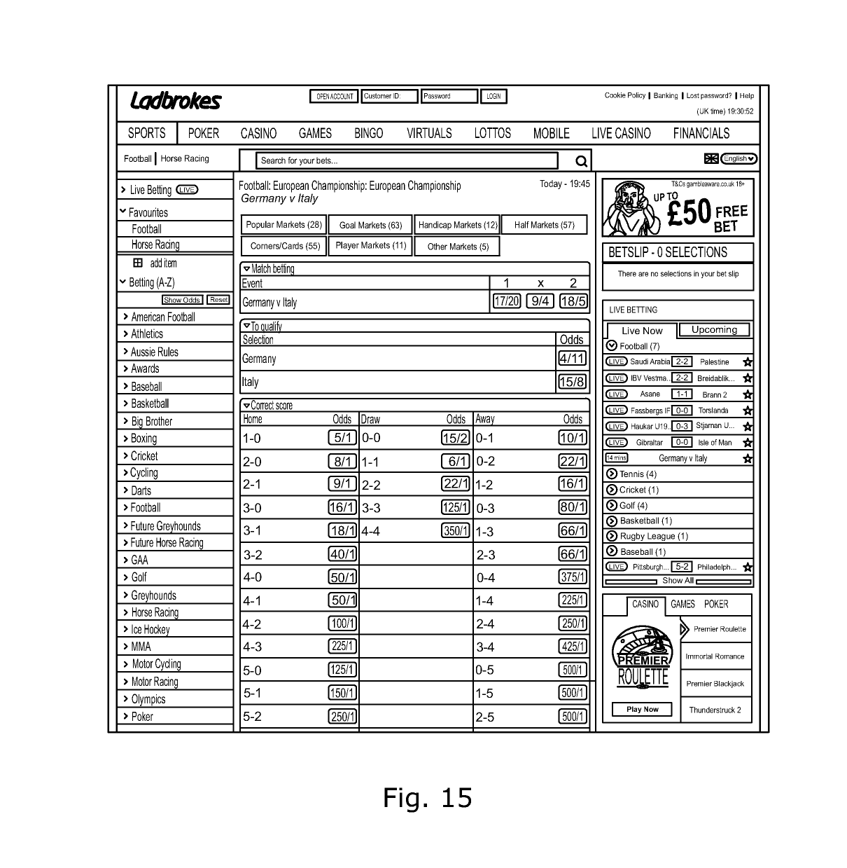

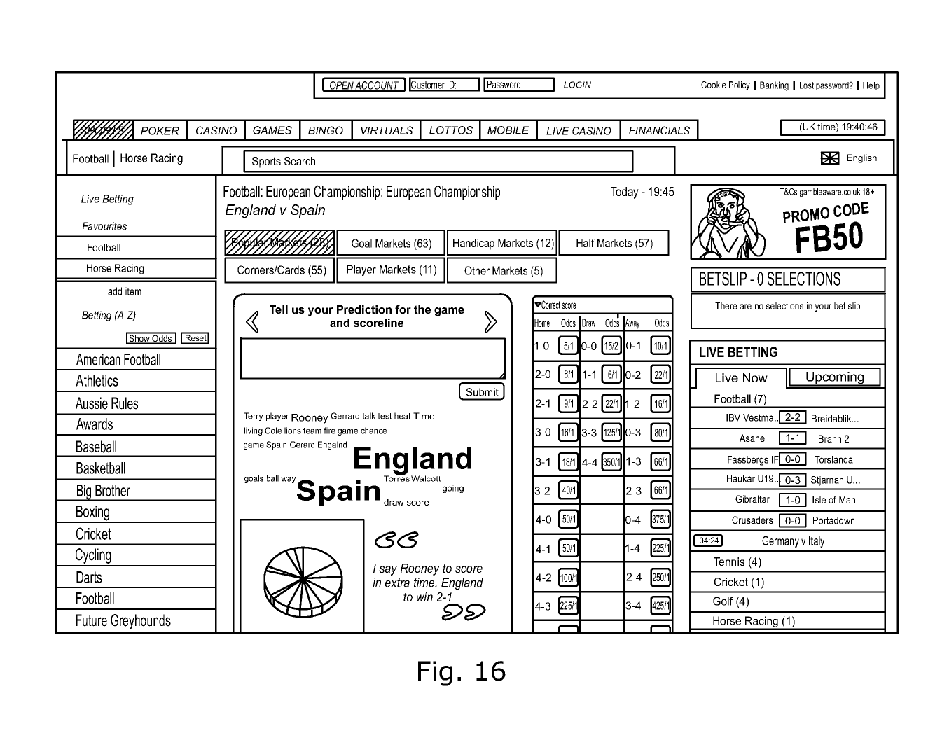

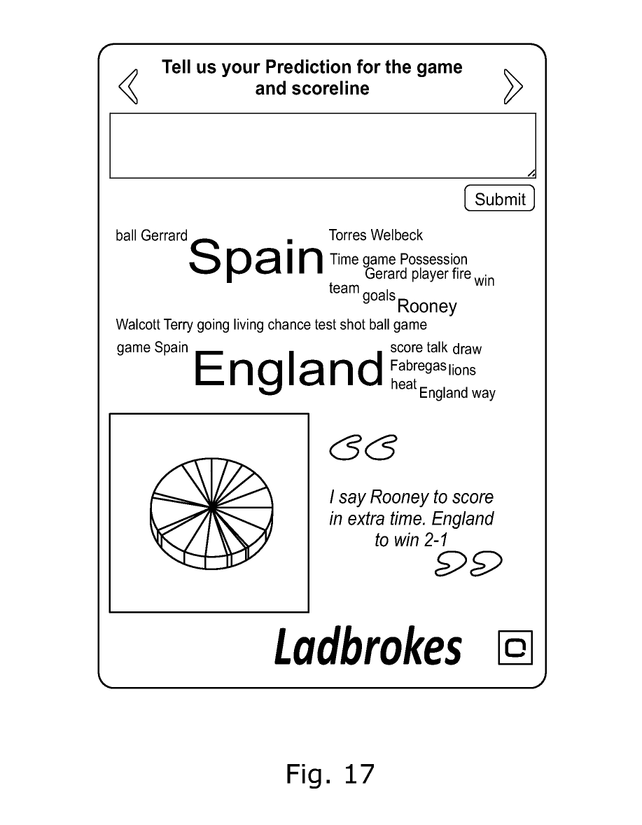

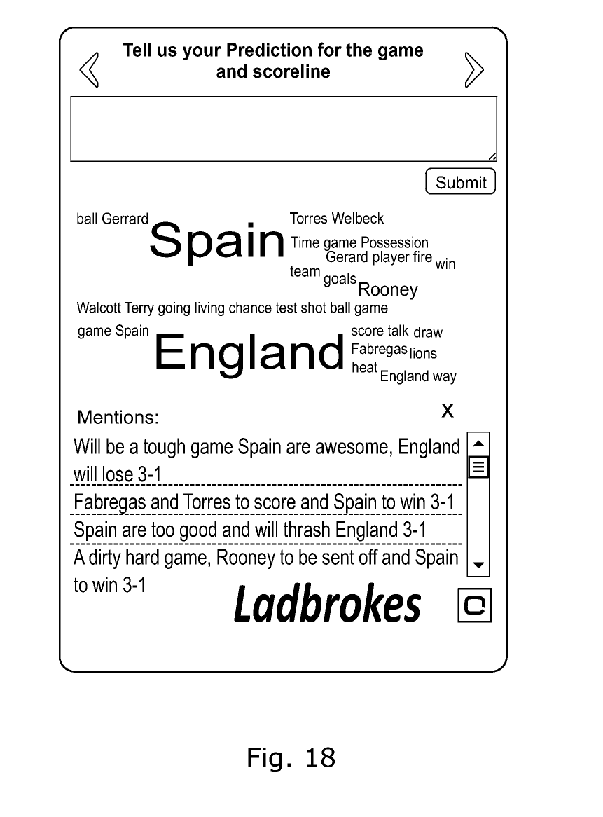

A second example is shown in FIGS. 15 to 19 for a gambling demo, in particular football. This demo illustrates how the system can be used for online sports gambling in the UK and Europe. From the PWC report on The Casino and Online Gaming Market to 2015: “The main challenge facing the industry during the next five years is knowing who its consumers are, understanding their changing needs and behaviors, and staying close to them, thereby ensuring the experience they provide is sufficiently compelling to override other potential choices.”

http://www.pwc.com/en_GX/Rx/entertainment-media/publications/assets/pdf/global-gaming-outlook.pdf

Industry Broker says: “The most important thing for me is the ability to know where people are going to bet.”

The example provides a widget that enables real-time engagement and moderated sentiment for the player, Score prediction and accurate sentiment analysis for the host gambling site. It may be embedded on every game in any sport with the ability to be hosted on affiliate site in addition to host gambling site.

It is envisaged that the gambling widget may bring several bENEFITs including an Ability to engage with the public weeks before a game/at game time/at half-time/during final minutes of a game, to determine where garners are trending

Mirroring the features in the Jaguar cars demo this embodiment also includes a specialized visualization/graph that shows where specialized extractions of score predictions fall. Red slices represent England winning, blue represents England, and gray represents a draw. Each slice represents a different score outcome. The score predictions have been extracted and combined to deal with different phrasings of an outcome. Just like the drilldowns in the tag cloud of the Jaguar demo to show comments, clicking on a slice on the graph displays comments relating to that score outcome. Note that score outcomes include other phrasing such as England lose 3-1 which grouped here with Spain win 3-1

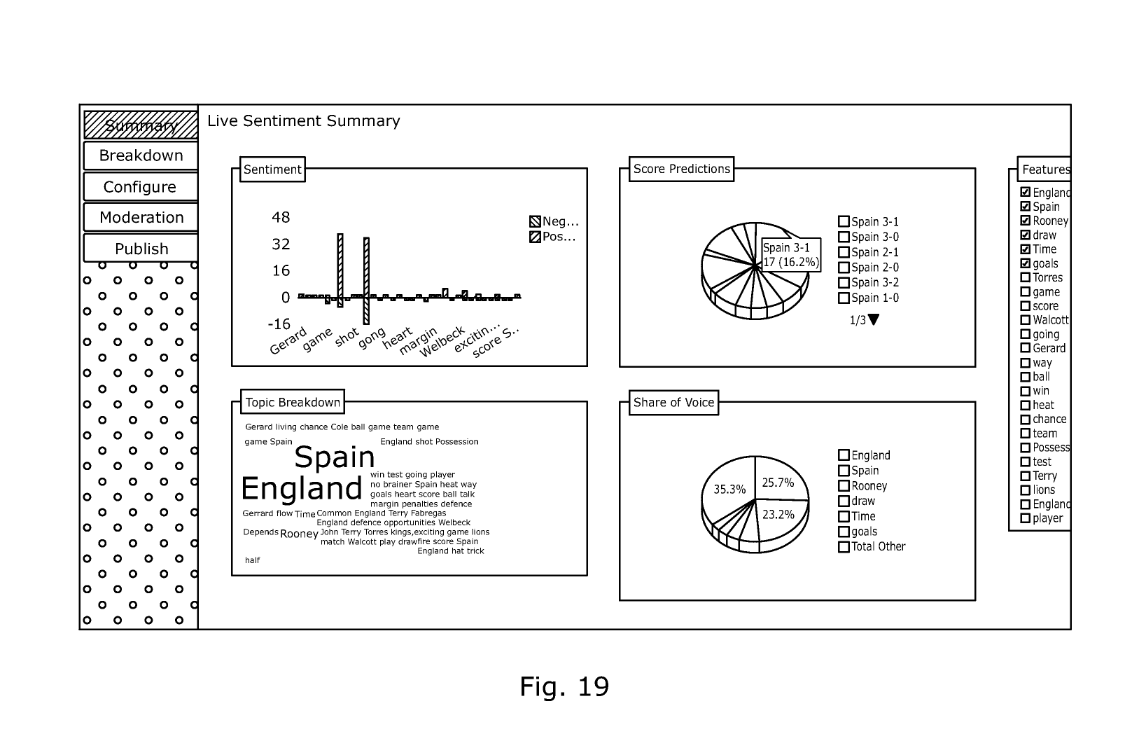

In this case, the dashboard that is shown in FIG. 19 is modified to meet the publisher's needs illustrating the score prediction chart previously mentioned.

### Gambling Demo 2—“Sensible Soccer”

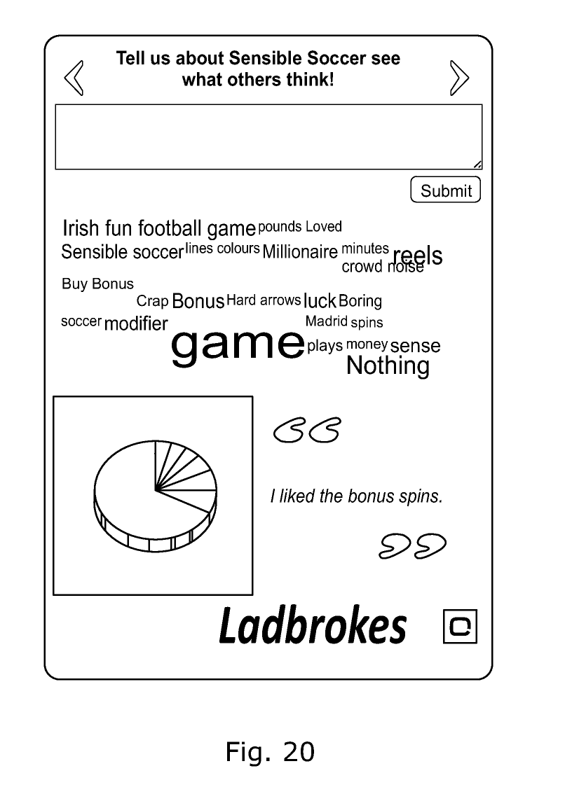

An alternative gambling demo is shown in FIG. 20. This demo illustrates how this can be used for feedback for online slots It provides game developer facility to recode the game as live analytics are collected from the player, the ability to quickly ascertain whether a game is popular or unpopular, and a capability for every game to have its own specific Octopii widget.

### Gambling Demo 2—Online Slots

Unlike the previous examples a widget may be provided that is used as a feedback mechanism where click-thrus now serve to help the user find similar games

As opposed to the jaguar demo where click-thrus are specifically defined, in this instance of the widget the publisher has defined integrated with search functionality such that finding a topic will lead to a search page of additional games which were described by users with the same topic.

A dashboard is provided that mimics precisely what aforementioned dashboards show including:
Summary Pages
Drilldowns
Configuration
Moderation
Publishing

### Retail Demo

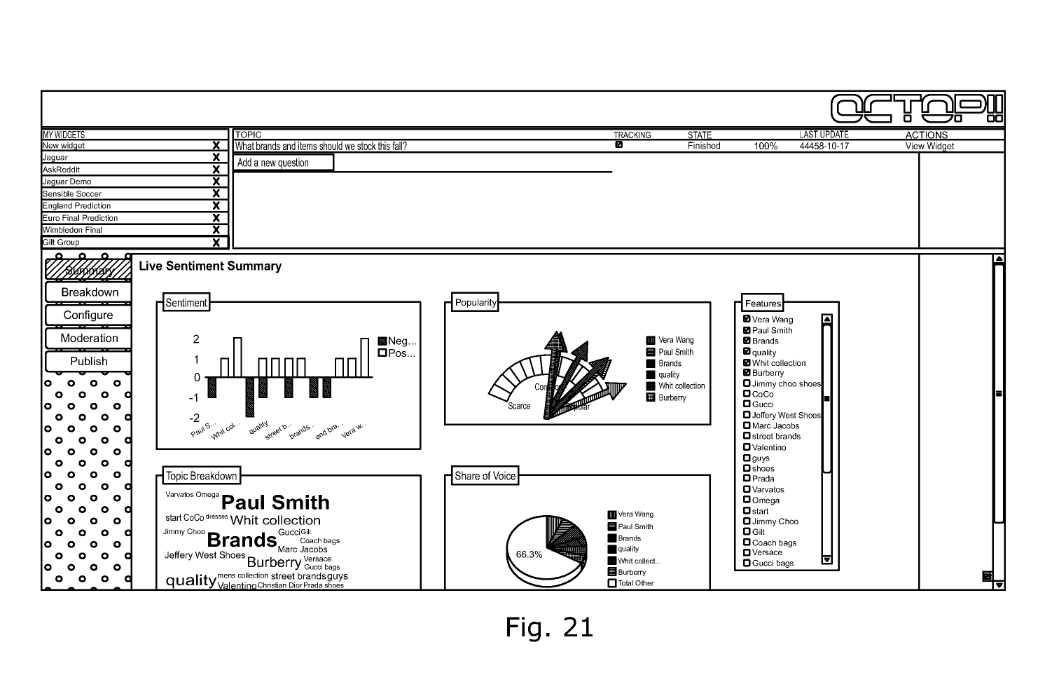

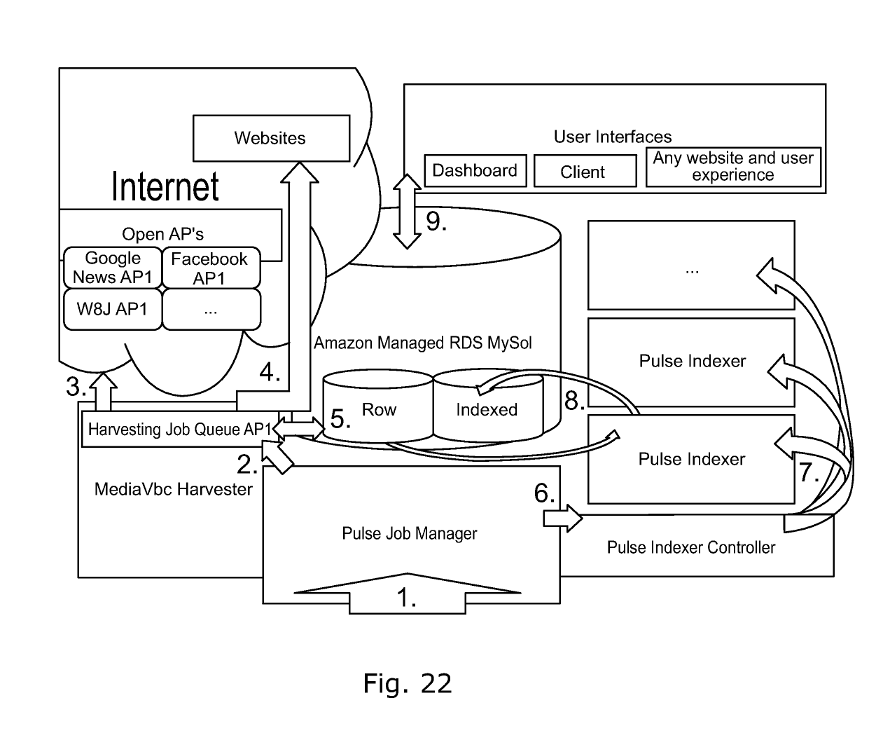

In another example, shown in FIG. 21, a retail widget is provided that may give specialty e-commerce retailers the ability to better meet their consumers needs and desires. It will enable them to benefit from real-time engagement with their customer to manage their expectations and be able to serve them better.

Although a widget is not shown, this illustrates the engines ability to work in other domains and work as a marketing feedback survey. When asked “What brands and items should we stock this fall?” Answers include not only specific brands, and sentiments on how people describe them but also more general and popular answers like a “mens collection”

### Extensibility

As illustrated through a variety of examples the engine and interface are applicable to a variety of purposes and include the ability to customize for a given purposes. The widgets enable people to TELL US WHAT YOU THINK AND WHAT OTHERS ARE SAYING, with Real-time audience engagement and feature extraction to provide Live analytics. This can be in the form of Bite-sized specific data collection, Live tickers, Sentiment bar charts, Popularity charts, Score predictor charts, Feature and sentiment breakdown with reviews. The widget is controlled by an interface that provides to the publisher moderation options.

Modifications mentioned include:
Ability to use click-thrus from the tag cloud for purposes beyond exploration of the conversation:
   Promotions
   Searches/Navigational Tool

Its notable to mention the extraction engine itself is capable of handling data across multiple domains adequately without specialized training based on natural language processing (NLP)

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

### Additional Designed Visualizations of Data

Another feature that can be included in exemplary widgets is the utilization of data based on dates, which allows grouping of topics to develop very pertinent visualizations showing trending using area charts and “motion graphs”. Another potential feature is to include within the area charts topics how often a topic is mentioned and how it changes over time.

The widget may be provided in the form of a YouTube search tool, or an Email search tool. Twitter Hash Tag may be provided as answers. By taking the twitter Tag Hash with auto hash tagging and the invention may compare every feature extracted to existing hash tag and merge them and re-tweet.

Lastly, a “US” app/widget may be provided linking friends and family based on “Forgotten Memories” idea with the ability to add Photos, Videos, Music, etc.

Having described the invention, what is claimed as new and secured by Letters Patent is:

1. A method of collecting and analyzing data over a network comprising:
prompting feedback from a plurality of users,
parsing the feedback received from one of said users into multiple parts and labeling each of said parts;
associating ones of said labeled parts based at least in part on spatial relationships to detect a sentiment of said feedback;
transforming said parts into numerical values;
parsing the feedback received from another of said users into multiple parts and labeling each of said parts from said another user;
associating ones of said labeled parts from said another user based at least in part on spatial relationships to detect a sentiment of said feedback from said another user;
transforming said parts from said another user into numerical values;
comparing said numerical values from said user with said numerical values from said another user to determine similarities between parts;
determining if a sentiment is positive; and,
displaying said similarities, said sentiment and said feedback in a chart.

2. The method according to claim 1 further comprising:
parsing said feedback into snippets of said feedback and mapping said snippets to said feedback; and,
emphasizing groups of said parts based on a frequency of occurrence.

3. The method according to claim 1 wherein at least some of the similarities, sentiment and feedback is displayed to the user.

4. A network analytical tool comprising:
a computer attached to the network and configured to prompt a plurality of users for feedback;
parse the feedback received from one of said users into multiple parts and label each of said parts;
associate ones of said labeled parts based at least in part on spatial relationships to detect a sentiment of said feedback;
transform said parts into numerical values;
parse the feedback received from another of said users into multiple parts and label each of said parts from said another user;
associate ones of said labeled parts from said another user based at least in part on spatial relationships to detect a sentiment of said feedback from said another user;
transform said parts from said another user into numerical values;
compare said numerical values from said user with said numerical values from said another user to determine similarities between parts;
determine if a sentiment is positive; and,
a display configured to display said similarities, said sentiment and said feedback in a chart
